(19) United States
(12) Patent Application Publication
(10) Pub. No.: US 2017/0277427 A1
(43) Pub. Date: Sep. 28, 2017

(54) CONTROL METHOD AND DEVICE FOR TERMINAL

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/335,417

(22) Filed: Oct. 26, 2016

Related U.S. Application Data
(63) Continuation of application No. PCT/CN2016/096426, filed on Aug. 23, 2016.

(30) Foreign Application Priority Data
Mar. 25, 2016 (CN) 2016101801256

(51) Int. Cl. G06F 3/0488; G09G 5/38; G06F 3/041

(52) U.S. Cl. CPC G06F 3/04886; G06F 3/0416; G09G 5/38; G09G 2340/0471; G09G 2340/0478

(57) ABSTRACT

The embodiments of the present disclosure provide a control method and device for a terminal. The control method for the terminal provided by the disclosure comprises the steps: acquiring operation information of a user at an edge touch area of the terminal; and controlling the display direction of a keyboard of the terminal according to the operation information of the user at the edge touch area of the terminal. The technical solutions of the present disclosure have the advantages that the operation is simple and convenient, the man-machine interaction efficiency is improved, and the problem of relatively low man-machine interaction efficiency caused by a reason that it is quite inconvenient to input data via the keyboard when the holding direction different from the display direction of the keyboard is adopted in the prior art can be solved.

### CROSS REFERENCE TO RELATED APPLICATIONS

The present disclosure is a continuation of international application No. PCT/CN2016/096426, filed on 23 Aug. 2016 which is based upon and claims the priority of Chinese Patent Disclosure No. 2016101801256, filed in Chinese Patent Office on Mar. 25, 2016, and entitled “CONTROL METHOD AND DEVICE FOR TERMINAL”, the entire contents of which are herein incorporated by reference.

### TECHNICAL FIELD

The present disclosure relates to the technical field of communications, and particularly relates to a control method and device for a terminal.

### BACKGROUND

Screens of current mainstream terminals are touch screens, and users operate the terminals by clicking or sliding functional keys and the like on the touch screens.

At present, man-machine interaction between a user and a terminal is mainly realized via a keyboard of the terminal, e.g., an input keyboard of the terminal, a password keyboard displayed when the terminal is unlocked, etc.

In the process of implementing the present disclosure, the inventor discovers that the prior art at least has the following problems: the holding direction of the user using the terminal may be different according to personal habit or the requirement for using the terminal, e.g., horizontal holding or vertical holding, but the keyboard of the terminal is generally in horizontal display or vertical display, so that when the holding direction different from the display direction of a keyboard is adopted, it is quite inconvenient to input data via the keyboard, and the input efficiency is relatively low.

### SUMMARY

In view of this, the embodiments of the present disclosure provide a control method and device for a terminal for solving the problem in the prior art that when the holding direction different from the display direction of a keyboard is adopted, it is quite inconvenient to input data via the keyboard, so that the input efficiency is relatively low.

To fulfill the above invention aim, in one aspect, an embodiment of the present disclosure provides a control method for a terminal, including the steps: acquiring operation information of a user operated at an edge touch area of the terminal; and controlling the display direction of a keyboard of the terminal according to the operation information of the user at the edge touch area of the terminal.

To fulfill the above invention aim, in a further aspect, an embodiment of the present disclosure provides a terminal, including at least one processor and a memory in communication connection with the at least one processor, wherein the memory stores an instruction which can be executed by the at least one processor, and the instruction is executed by the at least one processor, so that the at least one processor can: acquire operation information of a user at an edge touch area of the terminal; and control the display direction of a keyboard of the terminal according to the operation information of the user at the edge touch area of the terminal.

To fulfill the above invention aim, in a further aspect, an embodiment of the present disclosure further provides a non-transient computer readable storage medium, which stores a computer executable instruction used for: acquiring operation information of a user at an edge touch area of the terminal; and controlling the display direction of a keyboard of the terminal according to the operation information of the user at the edge touch area of the terminal.

### BRIEF DESCRIPTION OF THE DRAWINGS

One or more embodiments are illustrated via pictures in corresponding drawings, these illustrations do not limit the embodiments, components with the same reference numerical signs in the drawings are similar ones, and the pictures in the drawings do not have proportional limitations unless otherwise specified.

FIG. 1 is a flow diagram of embodiment 1 of a control method for a terminal provided by an embodiment of the present disclosure;

FIG. 2 is an exemplary diagram of an edge touch area of the terminal provided by an embodiment of the present disclosure;

FIG. 3 is a flow diagram of embodiment 2 of a control method for a terminal provided by an embodiment of the present disclosure;

FIG. 4 is a structural schematic diagram of a control device for a terminal provided by an embodiment of the present disclosure;

FIG. 5 is a schematic diagram of a hardware structure of a terminal for executing the control method for the terminal provided by an embodiment of the present disclosure.

### DETAILED DESCRIPTION

Preferred embodiments of the present disclosure will be illustrated below in combination with the accompanying drawings. It should be understood that the preferred embodiments described herein are merely used for illustrating and interpreting the present disclosure, rather than limiting the present disclosure.

It should be clear that the described embodiments are merely part of, not all of the embodiments of the present disclosure. Based on the embodiments in the present disclosure, all other embodiments obtained by those of ordinary skill in the art without any creative effort shall fall into the protection scope of the present disclosure.

The terms used in the embodiments of the present disclosure are for describing specific embodiments only, rather than limiting the present disclosure. Singular “one”, “said” and “the” used in the embodiments and the appended claims of the present disclosure also intend to include most forms, unless the context clearly expresses other meanings.

It should be understood that the term “and/or” used in the present disclosure is merely an association relation for describing associated objects, and can express three relations, for example, A and/or B can express: single A, both A and B, and single B. In addition, the symbol “/” in the present disclosure generally expresses an “or” relation between front and back associated objects.

Upon the context, the word “if” used herein can be interpreted as “at the time of . . . ” or “when . . . ” or “responding to determine” or “responding to detect”. Similarly, upon the context, the phrase “if determining” or “if detecting (the stated condition or event)” can be interpreted as “when determining” or “responding to determine” or “when detecting (the stated condition or event)” or “responding to detect (the stated condition or event)”.

### Embodiment 1

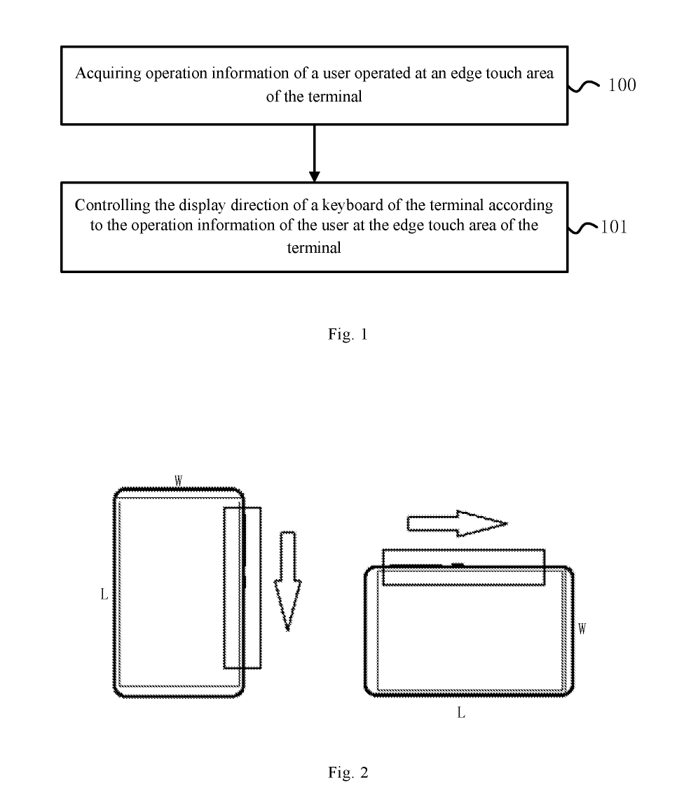

FIG. 1 is a flow diagram of embodiment 1 of a control method for a terminal provided by an embodiment of the present disclosure. As shown in FIG. 1, the method of this embodiment may include steps 100˜101.

100, acquiring operation information of a user at an edge touch area of the terminal.

For example, the terminal involved in the embodiment of the present disclosure may include but not limited to a personal computer (PC), a personal digital assistant (PDA), a wireless handheld device, a tablet computer, a mobile phone, an MP3 player, an MP4 player, etc.

In the embodiment of the present disclosure, the operation information of the user at the edge touch area of the terminal may include but not limited to: operation information generated after sliding operation of the user at the edge touch area of the terminal, e.g., sliding gesture; or operation information generated after clicking operation of the user at the edge touch area of the terminal, e.g., number of clicks; or operation information generated after pressing operation of the user at the edge touch area of the terminal, e.g., pressure value; or contact area of the user at the edge touch area.

It could be understood that edge touch is input via the edge or the border of the terminal to track clicking, sliding or pressing of a finger on the edge of the terminal so as to control the terminal.

Please refer to FIG. 2, which is an exemplary diagram of an edge touch area of the terminal provided by an embodiment of the present disclosure. As shown in FIG. 2, the edge touch area of the terminal may be an area that the finger of the user can reach on the sides of the terminal when the user naturally holds the terminal, and the sides of the terminal include other four sides except the front and the back.

In the embodiment of the present disclosure, the edge touch area of the terminal may be realized by a physical key, a virtual key, a sensor or a screen.

For example, if the terminal uses a curved screen, the edge touch area of the terminal can be realized by the edge screen of the curved screen. Taking a capacitive touch screen as an example for illustrating, when the finger of the user touches the edge touch screen, the capacitance of the contact is changed, so that the oscillator frequency related with the capacitance is changed, the touch position can be determined by measuring the change of the oscillator frequency, and then the operation information of the user at the edge touch area of the terminal can be acquired.

Or, for another example, the edge touch area of the terminal without using a curved screen can be realized by a physical key, a virtual key or a sensor.

For example, if a physical key for adjusting the volume is at the edge of the terminal, taking the physical key for adjusting the volume in the terminal as an example for illustrating, when the finger of the user presses the physical key for adjusting the volume, the terminal may learn that the user presses the key for improving the volume or the key for lowering the volume, and similarly, if the touch of the user at the edge tends to pressing operation, the operation information of the user at the edge touch area of the terminal can be acquired.

For another example, if virtual keys with certain functions are at the edge of the terminal and when the virtual keys are capacitive virtual keys, the terminal judges which virtual key the user touches via the capacitance of the capacitive virtual keys. Specifically, the finger and the electrode plate in a capacitive virtual key may form a capacitor when the user touches the capacitive virtual key, the terminal determines the touch position of the user by detecting the change of the capacitance so as to determine which virtual key the user touches, and then the operation information of the user at the edge touch area of the terminal can be acquired.

For a further example, if sensors with certain functions are at the edge of the terminal, taking the sensors which are pressure sensors on the terminal as an example, when the user presses a pressure sensor, semiconductor deformation pressure is formed on the flaky surface of the pressure sensor, the flaky surface is deformed by pressing to produce a piezoelectric impedance effect, the change of the impedance is converted into an electrical signal, and after acquiring the electrical signal, the terminal can determine which pressure sensor the user presses or which position on the pressure sensor the user presses so as to determine which function of the pressure sensor the user presses, or determine the contact area between the hand of the user and the terminal when the user holds the terminal, and then acquire the operation information of the user at the edge touch area of the terminal. In addition, the sensors with certain functions at the edge of the terminal may also be photo sensors.

Specifically, acquiring operation information of a user at an edge touch area of the terminal means acquiring operation information of the user on a valid area of the edge touch area of the terminal, and only the operation in the valid area can generate the corresponding operation information.

For example, if the terminal uses a curved screen, when the operation information of the user is acquired by using the edge screen of the curved screen at the edge touch area of the terminal, the valid area of the edge screen is a screen edge area that the finger of the user can click or contact when the user naturally holds the terminal.

101, controlling the display direction of a keyboard of the terminal according to the operation information of the user at the edge touch area of the terminal.

Specifically, different operation information is generated when the user carries out different operations on the terminal, and then corresponding functional modules of the terminal are triggered to fulfill the purpose of the operation information. Thus, the purpose fulfilled by the operation information of the user at the edge touch area of the terminal can be preset in the terminal.

For example, the interaction between the user and the terminal is mainly realized by the keyboard of the terminal, the terminal holding direction may be different when the user uses the terminal according to personal habit or the requirement for using the terminal, but the keyboard of the terminal is generally in horizontal display or vertical display, so that when the holding direction different from the display direction of a keyboard is adopted, it is inconvenient to input data via the keyboard, and the input efficiency is relatively low.

When the user naturally holds the terminal, the finger easily touches the edge touch area of the terminal, so the purpose to be fulfilled by a certain piece of operation information in the operation information of the user at the edge touch area of the terminal can be set to control the display direction of the keyboard of the terminal. In this case, the user can carry out operation at the edge touch area of the terminal according to own current terminal holding direction, and after the operation information of the user at the edge touch area of the terminal is acquired, the operation information may trigger the terminal, so that the display direction of the keyboard of the terminal is consistent with the terminal holding direction of the user.

It should be noted that the execution main body of the control method for the terminal in the embodiment of the present disclosure may be a control device for the terminal, the device may be located at an disclosure of the local terminal or at a functional unit such as a plug-in or software development kit (SDK) and the like in the disclosure of the local terminal, and the embodiment of the present disclosure is not specially limited thereto.

It could be understood that the disclosure may be an disclosure program (nativeApp) installed on the terminal or a web program (webApp) of a browser on the terminal, and the embodiment of the present disclosure is not limited thereto.

In the control method for the terminal provided by the embodiment of the present disclosure, operation information of a user at an edge touch area of the terminal is acquired, and the display direction of the keyboard of the terminal is controlled according to the acquired operation information of the user at the edge touch area of the terminal. In the present disclosure, the display direction of the keyboard of the terminal can be conveniently and quickly controlled by operation at the edge touch area of the terminal. Thus, the technical solution of the present disclosure has the advantages that when the display direction of the keyboard of the terminal is controlled, the operation is simple and convenient, the input efficiency is improved, and the problem of relatively low input efficiency caused by a reason that it is quite inconvenient to input data via the keyboard when the holding direction different from the display direction of the keyboard is adopted in the prior art can be solved.

### Embodiment 2

FIG. 3 is a flow diagram of embodiment 2 of a control method for a terminal provided by an embodiment of the present disclosure. As shown in FIG. 3, the control method for the terminal provided by the embodiment of the present disclosure further describes the technical solution of the embodiment of the present disclosure based on the embodiment shown in FIG. 1.

As shown in FIG. 3, the control method for the terminal provided by the embodiment of the present disclosure may specifically include steps 300˜302.

300, acquiring operation information of a user at an edge touch area of the terminal.

301, acquiring contact area of the user at the edge touch area according to the operation information of the user at the edge touch area of the terminal.

302, controlling the display direction of the keyboard of the terminal according to the contact area of the user at the edge touch area

Specifically, the terminal in a horizontal screen state or a vertical screen state can be judged according to the contact area of the user at the edge touch area.

For example, the terminal needs to be switched between the horizontal screen state and the vertical screen state due to its oblong screen. As shown in FIG. 2, when the terminal is in the horizontal screen state, the user generally holds two short edges W of the terminal, the hand of the user contacts the short edges W of the terminal, in this case, the contact areas between the hand of the user and the short edges W of the terminal are greater than those between the hand of the user and the long edges L of the terminal, then the terminal in the horizontal screen state can be judged, and the keyboard is horizontally displayed on the screen. Otherwise, when the terminal is in the vertical screen state, the user generally holds two long edges L of the terminal, the hand of the user contacts the long edges L of the terminal, in this case, the contact areas between the hand of the user and the long edges L of the terminal are greater than those between the hand of the user and the short edges W of the terminal, then the terminal in the vertical screen state can be judged, and the keyboard is vertically displayed on the screen.

Generally, the keyboard of the terminal includes a password keyboard displayed when the terminal is unlocked or an input keyboard of the terminal. If the user is using the terminal and the terminal has displayed a keyboard interface, it indicates that the keyboard direction of the terminal has been displayed in the horizontal direction or the vertical direction at the moment, and only the display direction of the keyboard of the terminal needs to be adjusted to be consistent with the terminal holding direction of the user. If the user does not use the terminal, the terminal may be in a screen locking and extinguishing state, the keyboard of the terminal at the moment is a password keyboard displayed when the terminal is unlocked, the screen of the terminal needs to be lightened, and the password keyboard is displayed vertically or horizontally on the screen according to the terminal holding direction of the user.

In the control method for the terminal provided by the embodiment of the present disclosure, operation information of a user at an edge touch area of the terminal is acquired, and the display direction of the keyboard of the terminal is controlled according to the acquired operation information of the user at the edge touch area of the terminal. In the present disclosure, the display direction of the keyboard of the terminal can be conveniently and quickly controlled by operation at the edge touch area of the terminal. Thus, the technical solution of the present disclosure has the advantages that when the display direction of the keyboard of the terminal is controlled, the operation is simple and convenient, the input efficiency is improved, and the problem of relatively low input efficiency caused by a reason that it is quite inconvenient to input data via the keyboard when the holding direction different from the display direction of the keyboard is adopted in the prior art can be solved.

### Embodiment 3

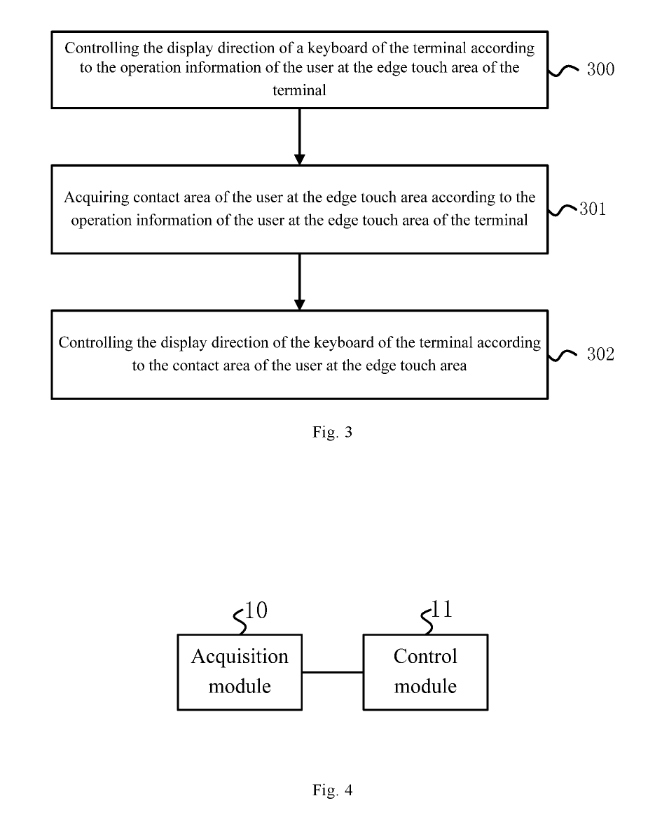

FIG. 4 is a structural schematic diagram of a control device for a terminal provided by an embodiment of the present disclosure. As shown in FIG. 4, the control device for the terminal provided by the embodiment of the present disclosure includes an acquisition module 10 and a control module 11.

In a specific implementation process, the modules can transmit information data and the like therebetween.

The acquisition module 10 is used for acquiring operation information of a user at an edge touch area of the terminal.

The control module 11 is used for controlling the display direction of a keyboard of the terminal according to the operation information of the user at the edge touch area of the terminal.

In the control device for the terminal provided by the embodiment of the present disclosure, the implementation mechanism of controlling the display direction of the keyboard of the terminal by adopting the above modules is the same as that of the embodiment shown in FIG. 1 above, and reference may be made to the recording of the embodiment shown in FIG. 1, which is not redundantly described herein.

Further, in a specific implementation process, the control module 11 in the control device for the terminal of the above embodiment is specifically used for: acquiring contact area of the user at the edge touch area according to the operation information of the user at the edge touch area of the terminal; and controlling the display direction of the keyboard of the terminal according to the contact area of the user at the edge touch area.

Specifically, the control module 11 can judge that the terminal is in a horizontal screen state or a vertical screen state according to the contact area of the user at the edge touch area; if the terminal in the horizontal screen state is judged, the keyboard is horizontally displayed on the screen; and if the terminal in the vertical screen state is judged, the keyboard is vertically displayed on the screen.

For example, the keyboard of the terminal includes a password keyboard displayed when the terminal is unlocked or an input keyboard of the terminal. If the user is using the terminal and the terminal has displayed a keyboard interface, the control module 11 at the moment is specifically used for adjusting the display direction of the keyboard of the terminal. If the user does not use the terminal, the terminal may be in a screen locking and extinguishing state, the keyboard of the terminal at the moment is a password keyboard displayed when the terminal is unlocked, and the control module 11 is specifically used for lightening the screen of the terminal and vertically or horizontally displaying the password keyboard on the screen.

In the control device for the terminal provided by the embodiment of the present disclosure, the implementation mechanism of controlling the display direction of the keyboard of the terminal by adopting the above modules is the same as that of the embodiment shown in FIG. 3 above, and reference may be made to the recording of the embodiment shown in FIG. 3, which is not redundantly described herein.

In the control device for the terminal provided by the embodiment of the present disclosure, an acquisition module 10 in the terminal acquires operation information of a user at an edge touch area of the terminal, and a control module 11 in the terminal controls the display direction of the keyboard of the terminal according to the acquired operation information of the user at the edge touch area of the terminal. In the present disclosure, the display direction of the keyboard of the terminal can be conveniently and quickly controlled by operation at the edge touch area of the terminal. Thus, the technical solution of the present disclosure has the advantages that when the display direction of the keyboard of the terminal is controlled, the operation is simple and convenient, the input efficiency is improved, and the problem of relatively low input efficiency caused by a reason that it is quite inconvenient to input data via the keyboard when the holding direction different from the display direction of the keyboard is adopted in the prior art can be solved.

### Embodiment 4

The embodiment of the present disclosure provides a non-volatile computer storage medium, the computer storage medium stores a computer executable instruction, and the computer executable instruction can execute the processing method in any above method embodiment.

### Embodiment 5

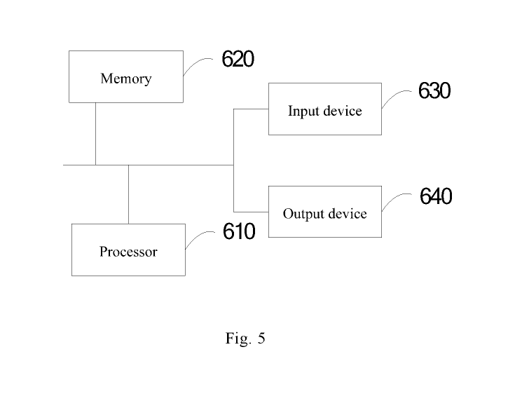

FIG. 5 is a schematic diagram of a hardware structure of a terminal for executing the control method for the terminal provided by an embodiment of the present disclosure. As shown in FIG. 5, the terminal includes one or more processors 610 and a memory 620. One processor 610 is taken as an example in FIG. 5. The terminal may further include an input device 630 and an output device 640.

The processor 610, the memory 620, the input device 630 and the output device 640 can be connected via a bus or in other modes, taking bus connection as an example in FIG. 5.

The memory 620 serving as a non-volatile computer readable storage medium can be used for storing non-volatile software programs, non-volatile computer executable programs and modules. The processor 610 runs the non-volatile software programs, instructions and programs stored in the memory 620 to execute various functional disclosures and data processing of the terminal, i.e., to implement the processing method in the above method embodiments.

The memory 620 may include a program storage area and a data storage area, wherein the program storage area can store an operating system and an disclosure program required by at least one function; and the data storage area can store data and the like. Moreover, the memory 620 may include a high-speed random access memory, and may also include a non-volatile memory, e.g., at least one disk storage device, a flash device or other non-volatile solid-state storage devices. In some embodiments, the memory 620 may include memories arranged remotely relative to the processor 610, and these remote memories can be connected to the processor via a network. The example of the network includes but not limited to the internet, an intranet, a local area network, a mobile communication network and a combination thereof.

The input device 630 can receive input digit or character information and generate signal input. The output device 640 may include display equipment such as a display screen.

The one or more modules are stored in the memory 620, and are executed by the one or more processors 610 to execute: acquiring operation information of a user at an edge touch area of the terminal; and controlling the display direction of a keyboard of the terminal according to the operation information of the user at the edge touch area of the terminal.

According to the above aspect and any possible implementation, further provided is an implementation, wherein the step of controlling the display direction of a keyboard of the terminal according to the operation information of the user at the edge touch area of the terminal includes: acquiring contact area of the user at the edge touch area according to the operation information of the user at the edge touch area of the terminal; and controlling the display direction of the keyboard of the terminal according to the contact area of the user at the edge touch area.

According to the above aspect and any possible implementation, further provided is an implementation, wherein the step of controlling the display direction of the keyboard of the terminal according to the contact area of the user at the edge touch area includes: judging that the terminal is in a horizontal screen state or a vertical screen state according to the contact area of the user at the edge touch area; if the terminal in the horizontal screen state is judged, horizontally displaying the keyboard on the screen; and if the terminal in the vertical screen state is judged, vertically displaying the keyboard on the screen.

According to the above aspect and any possible implementation, further provided is an implementation, wherein the keyboard of the terminal includes a password keyboard displayed when the terminal is unlocked or an input keyboard of the terminal.

According to the above aspect and any possible implementation, further provided is an implementation, wherein the step of controlling the display direction of the keyboard of the terminal includes: adjusting the display direction of the keyboard of the terminal.

According to the above aspect and any possible implementation, further provided is an implementation, wherein if the keyboard of the terminal is a password keyboard displayed when the terminal is unlocked, the step of controlling the display direction of the keyboard of the terminal includes: lightening the screen of the terminal, and vertically or horizontally displaying the password keyboard on the screen.

The above product can execute the methods provided by the embodiments of the present disclosure, and has corresponding functional modules for executing the methods and corresponding beneficial effects. For the technical details not described in detail in this embodiment, reference may be made to the methods provided by the embodiments of the present disclosure.

The terminal in the embodiments of the present disclosure exists in multiple forms, including but not limited to: mobile communication equipment: the equipment has a mobile communication function, and has the main goals of providing speech and data communication. The terminal includes: a smart phone (e.g., iPhone), a multimedia phone, a functional phone, a low-end phone, etc.

Ultra-mobile personal computer equipment: the equipment belongs to the scope of personal computers, has computing and processing functions, and generally also has mobile internet characteristic. The terminal includes PDA, MID (Mobile Internet Device) and UMPC (Ultra Mobile Personal Computer) equipment and the like, e.g., iPad.

Portable entertainment equipment: the equipment can display and play multimedia contents. The equipment includes audio and video players (e.g., iPod), handheld game players, electronic books, intelligent toys and portable vehicle-mounted navigation equipment.

Server: equipment for providing computing services, including a processor, a hard disk, a memory, a system bus, etc., wherein the architecture of the server is similar to that of a general computer, but the server is highly required on the aspects of processing capability, stability, reliability, security, expandability, manageability and the like because it needs to provide high reliable services.

Other electronic devices with data interaction functions.

The above-described device embodiments are only schematic, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part of or all of the units according to actual needs.

Upon the descriptions of the above embodiments, those skilled in the art can clearly learn that each embodiment can be realized by means of software and a general hardware platform, and of course, can be realized via hardware. Based on such an understanding, the above technical solutions substantially or the parts making contribution to relevant technologies may be embodied in the form of a software product, and the computer software product can be stored in a storage medium, such as an ROM (Read-Only Memory)/RAM (Random Access Memory), a magnetic disk, an optical disk, etc., which includes a plurality of instructions enabling computer equipment (which may be a personal computer, a server, or network equipment and the like) to execute each embodiment or the method in some part of each embodiment.

Finally, it should be noted that the above embodiments are merely used for illustrating the technical solutions of the present disclosure, rather than limiting the present disclosure; though the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to a part of technical characteristics thereof; and these modifications or substitutions do not make the nature of the corresponding technical solutions depart from the spirit and scope of the technical solutions of the respective embodiments of the present disclosure.

### INDUSTRIAL APPLICABILITY

According to the control method and device for the terminal provided by the embodiments of the present disclosure, operation information of a user at an edge touch area of the terminal is acquired, and the display direction of the keyboard of the terminal is controlled according to the operation information of the user at the edge touch area of the terminal, so that when the display direction of the keyboard of the terminal is controlled, the operation is simple and convenient, and the input efficiency is improved.

1. A control method for a terminal, comprising the steps:
acquiring operation information of a user operated at an edge touch area of the terminal; and
controlling the display direction of a keyboard of the terminal according to the operation information of the user at the edge touch area of the terminal.

2. The method of claim 1, wherein the step of controlling the display direction of a keyboard of the terminal according to the operation information of the user at the edge touch area of the terminal comprises:
acquiring contact area of the user at the edge touch area according to the operation information of the user operated at the edge touch area of the terminal; and
controlling the display direction of the keyboard of the terminal according to the contact area of the user at the edge touch area.

3. The method of claim 2, wherein the step of controlling the display direction of the keyboard of the terminal according to the contact area of the user at the edge touch area comprises:
judging that the terminal is in a horizontal screen state or a vertical screen state according to the contact area of the user at the edge touch area;
if the terminal in the horizontal screen state is judged, horizontally displaying the keyboard on the screen; and
if the terminal in the vertical screen state is judged, vertically displaying the keyboard on the screen.

4. The method of claim 1, wherein the keyboard of the terminal comprises a password keyboard displayed when the terminal is unlocked, or an input keyboard of the terminal.

5. The method of claim 4, wherein the step of controlling the display direction of the keyboard of the terminal comprises: adjusting the display direction of the keyboard of the terminal.

6. The method of claim 4, wherein if the keyboard of the terminal is a password keyboard displayed when the terminal is unlocked, the step of controlling the display direction of the keyboard of the terminal comprises:
lightening the screen of the terminal, and vertically or horizontally displaying the password keyboard on the screen.

7. A terminal, comprising:
at least one processor; and
a memory in communication connection with the at least one processor, wherein
the memory stores an instruction which can be executed by the at least one processor, and the instruction is executed by the at least one processor, so that the at least one processor can: acquire operation information of a user at an edge touch area of the terminal; and
control the display direction of a keyboard of the terminal according to the operation information of the user at the edge touch area of the terminal.

8. The terminal of claim 7, wherein the step of controlling the display direction of a keyboard of the terminal according to the operation information of the user at the edge touch area of the terminal comprises:
acquiring contact area of the user at the edge touch area according to the operation information of the user at the edge touch area of the terminal; and
controlling the display direction of the keyboard of the terminal according to the contact area of the user at the edge touch area.

9. The terminal of claim 8, wherein the step of controlling the display direction of the keyboard of the terminal according to the contact area of the user at the edge touch area comprises:
judging that the terminal is in a horizontal screen state or a vertical screen state according to the contact area of the user at the edge touch area;
if the terminal in the horizontal screen state is judged, horizontally displaying the keyboard on the screen; and
if the terminal in the vertical screen state is judged, vertically displaying the keyboard on the screen.

10. The terminal of claim 7, wherein the keyboard of the terminal comprises a password keyboard displayed when the terminal is unlocked or an input keyboard of the terminal.

11. The terminal of claim 10, wherein the step of controlling the display direction of the keyboard of the terminal comprises: adjusting the display direction of the keyboard of the terminal.

12. The terminal of claim 10, wherein if the keyboard of the terminal is a password keyboard displayed when the terminal is unlocked, the step of controlling the display direction of the keyboard of the terminal comprises:
lightening the screen of the terminal, and vertically or horizontally displaying the password keyboard on the screen.

13. A non-transient computer readable storage medium, wherein
the non-transient computer readable storage medium stores a computer executable instruction, which is used for: acquiring operation information of a user at an edge touch area of the terminal; and
controlling the display direction of a keyboard of the terminal according to the operation information of the user at the edge touch area of the terminal.

14. The non-transient, computer readable storage medium of claim 13, wherein the step of controlling the display direction of a keyboard of the terminal according to the operation information of the user at the edge touch area of the terminal comprises:
acquiring contact area of the user at the edge touch area according to the operation information of the user at the edge touch area of the terminal; and
controlling the display direction of the keyboard of the terminal according to the contact area of the user at the edge touch area.

15. The non-transient computer readable storage medium of claim 14, wherein the step of controlling the display direction of the keyboard of the terminal according to the contact area of the user at the edge touch area comprises:
judging that the terminal is in a horizontal screen state or a vertical screen state according to the contact area of the user at the edge touch area;
if the terminal in the horizontal screen state is judged, horizontally displaying the keyboard on the screen; and
if the terminal in the vertical screen state is judged, vertically displaying the keyboard on the screen.

16. The non-transient computer readable storage medium of claim 13, wherein the keyboard of the terminal comprises a password keyboard displayed when the terminal is unlocked or an input keyboard of the terminal.

17. The non-transient computer readable storage medium of claim 16, wherein the step of controlling the display direction of the keyboard of the terminal comprises: adjusting the display direction of the keyboard of the terminal.

18. The non-transient computer readable storage medium of claim 16, wherein if the keyboard of the terminal is a password keyboard displayed when the terminal is unlocked, the step of controlling the display direction of the keyboard of the terminal comprises:
lightening the screen of the terminal, and vertically or horizontally displaying the password keyboard on the screen.
